(19) United States
(12) Patent Application Publication
(10) Pub. No.: US 2007/0224312 A1
(43) Pub. Date: Sep. 27, 2007

(54) Sealed package for multiple products

(75) Inventor: Allen Sydney Aldridge, South Orange, NJ (US)

Correspondence Address: HOFFMANN & BARON, LLP, 6900 JERICHO TURNPIKE, SYOSSET, NY, 11791, US

(73) Assignee: Cadbury Adams USA LLC.

(21) Appl. No.: 11/709,304

(22) Filed: Feb. 21, 2007

Related U.S. Application Data
(60) Provisional application No. 60/775,137, filed on Feb. 21, 2006.

(51) Int. Cl. A23G 4/18

(52) U.S. Cl. 426/5

(57) ABSTRACT

A multi-package for containing a plurality of discrete products, includes a wrapper defined by a pair by spaced apart planar surfaces. The planar surfaces enclosed the product in spaced apart relationship. The surfaces are sealed to each other at locations between the spaced apart products to individually enclose each of the products. One of the discrete products may be removed from the package while maintaining the rest of the products in sealed relationship.

### CROSS-REFERENCE TO RELATED APPLICATIONS

This application claims priority to U.S. Provisional Application No. 60/775,137, filed Feb. 21, 2006, which is incorporated herein by reference.

### FIELD OF THE INVENTION

The present invention relates generally to a packaging technique for individually supporting a plurality of product packages containing consumable products in a manner which allows the products to be displayed and merchandised. More particularly, the present invention provides a package which allows the display and merchandising of a plurality of packaged products.

### BACKGROUND

In the sale of discrete products, especially consumable products, more particularly chewing gum, individual gum sticks, slabs, or the like, are housed in a package which allows access to the individual gum sticks or gum slabs contained therein. A plural of these packages may be housed in an outer package or wrapper which allows the individual packages to be sold in multiples and which allows the multiple packages to be displayed for merchandising. Once purchased, these multiple packages should allow for the removal of one of the individual packages therefrom.

Also, in the packaging of consumable products such as gum, it is often necessary to individually seal or package the gum. One reason for this is, for example, to prevent flavor migration between packages.

Heretofore, it has been difficult to house, in a multi-package arrangement, individually sealed packages.

It is, therefore, desirable to provide a multi-package for containing products including consumable products such as gum packages which allows for display and merchandising of the multi-package and yet seals the individual packaged product and allows for merchandising of the multi-package.

### SUMMARY OF THE INVENTION

The present invention provides a multi-package for containing a plurality of discrete products. The multi-package includes a wrapper defining a pair of spaced apart planar surfaces for enclosing the products in spaced apart relationship. The surfaces may be sealed to each other at locations between the spaced apart products to individually enclose each product.

In some embodiments, the products may be gum, candy, chocolate, or other confectionary.

In a preferred embodiment, the products are gum sticks, pellets, chunks, pillows, or slabs, a plurality of which are contained in an individual gum dispenser or other package. Each gum package may contain gum of a single flavor type. Plural packages having gum of different flavor types may be supported within the wrapper where flavor migration between the gum packages is reduced and potentially prevented. The sealed location between the spaced apart product package may include a perforation therethrough so as to allow separation of one product from the wrapper.

### BRIEF DESCRIPTION OF THE DRAWINGS

FIG. 1 is a plan representation of the multi-package of the present invention.

FIG. 2 is a perspective showing of the multi-package of FIG. 1 containing multiple gum packages.

FIG. 3 is an enlarged showing of a portion of a further embodiment of the product package of FIG. 1.

FIG. 4 is a perspective side views of a multi-package of the present invention showing gum packages of different flavor types.

FIG. 5 is a front plan view of a further embodiment of a multi-package of the present invention supporting gum packages of different flavor types.

FIG. 6 is a perspective side view of the multi-package of FIG. 5.

FIG. 7 is a front plan view of a flat block used to form a further embodiment of a multi-package of the present invention.

### DETAILED DESCRIPTION OF THE PREFERRED EMBODIMENT

Referring to the Figures, a multi-package 10 for containing a plurality of consumable products is shown. The multi-package 10 may hold a variety of similar or different individual packages.

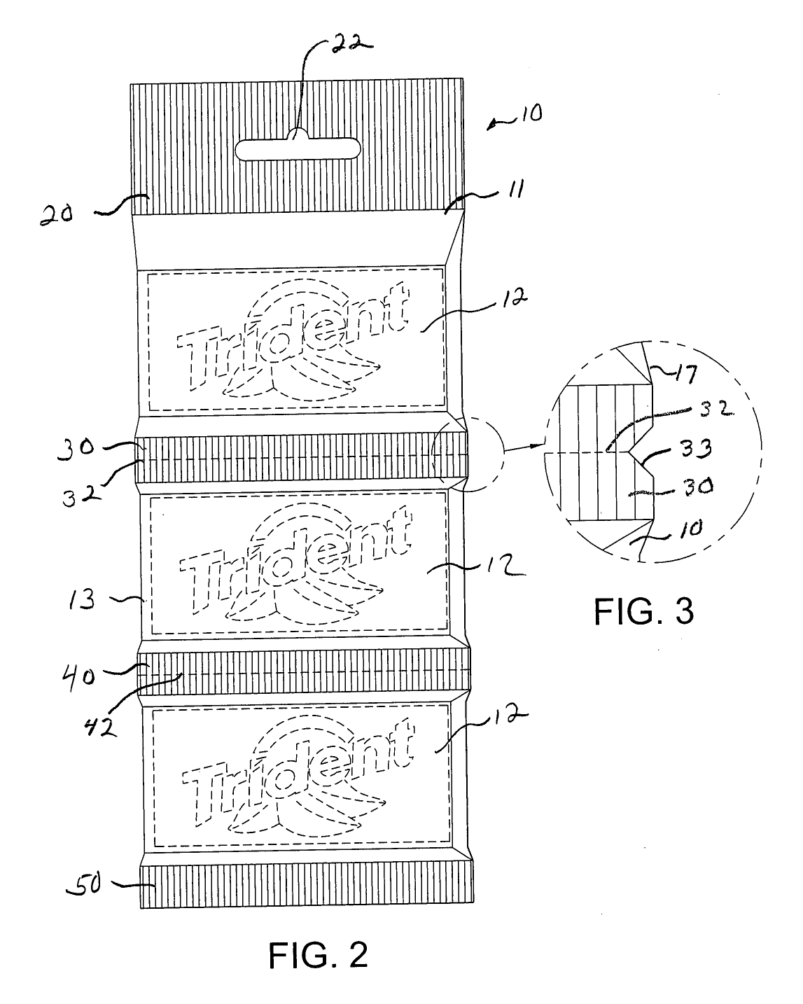

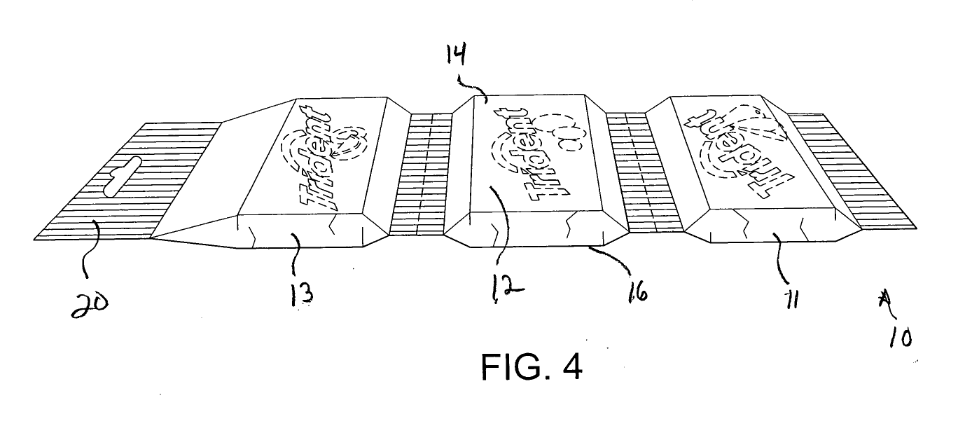

In the present illustrative embodiment, multi-package 10 supports a plurality of individual gum packages 12 in a vertically arranged, spaced apart relationship. Each package is maintained in a sealed compartment 13. Each gum package 12 may support a plurality of gum slabs or sticks or other configurations (not shown). It is contemplated that each gum package may support the gum slabs or sticks of one type or of different types. For example, as shown in FIG. 2, mint flavored gum is supported in each package 12. Furthermore, as shown in FIG. 4, the present invention also allows gum packages 12, each supporting a gum of a different flavor type, to be supported in the individual multi-package 10.

It is contemplated that the flavor types may include, but are not limited to mint base flavors such as peppermint and spearmint, fruit based flavors such as apple and orange, and vanilla based flavors.

It is also contemplated that different types of packaging may be used in accordance with the present invention. While stick or slab packages are shown, other types of packages such as blister packages and other types of dispensers may also be accommodated by the multi-package of the present invention. While the preferred embodiments show gum packages for accommodating gum slabs, it is not limited thereto. The multi-package 10 may support packages such as slab packages, stick packages, and pellet packages including blister packages. Also, each multi-package may support packages of the same type or different types.

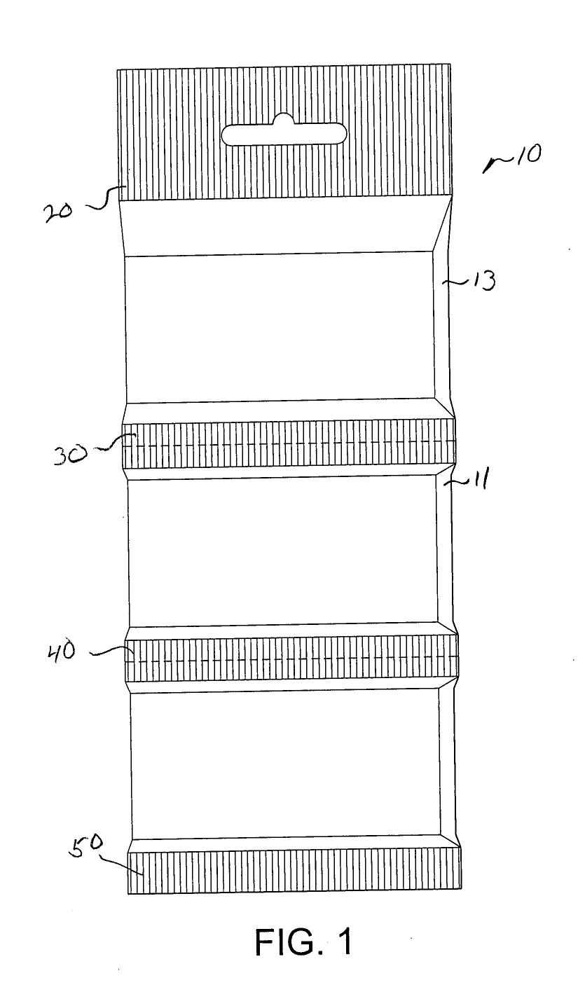

Additionally, while packages 12 are shown in FIGS. 1 and 2 for each compartment 13, it is contemplated that one or more compartments 13 may support wrapped or unwrapped products or a mixture of both without an additional package. Also, one or more of the products/packages 12 may be overwrapped to provide additional protection.

As noted, it is contemplated that within a single multi-package different types of gum packages may be sold together as a unit. It is also contemplated that each individual package may include gum pieces of different types such as slabs, sticks, pellets, chunks, pillows or the like.

Moreover, the same or different type of gum packages may contain gum products having the same or different flavors, functional ingredients, functional benefits, product forms, or sensates.

It is further contemplated that the multi-package of the present invention may include products having functional relationships based on its different functional ingredients. For example, the ingredients may include breath freshening, appetite suppression, teeth whitening, or hydration ingredients. These similar or different functional ingredients may be linked by a common theme. The theme may related to usage, flavors or benefits of the products or combinations thereof. For example, one theme may be oral care and the functional ingredients may include ingredients which provide for teeth whitening and breath freshening. Thus, the multi-package 10 may contain different confectionery products, some of which have teeth whitening ingredients and some of which have breath freshening ingredients and some may have both.

Moreover, the multi-package may include packages having different related themes, such as gum having flavors with different intensities such as mint, cinnamon or the like or sensates with different intensities. For example, related themes such as sweet and sour may be included in a single multi-package. More specifically, for example, one package 12 in the multi-package 10 may contain stick shaped gum products having a mild peppermint or cinnamon flavor. Another package 12 in the multi-package 10 may contain stick shaped gum products having a significantly more intense peppermint or cinnamon flavor. As a further example, one package 12 in the multi-package 10 may contain slab shaped gum products having a sweet apple flavor. Another package 12 in the multi-package 10 may contain slab shaped gum products having a sour apple flavor. A third package 12 in the multi-package may contain pellet shaped gum products, some of which have a sour apple flavor and some of which have a sweet apple flavor.

Moreover, each package may include gum or other products having a different health and different teeth related benefits such as, for example, whitening, stain removal, plaque removal, energy, concentration assistance, remineralisation and the like. Different or related products of this type may be included in a single multi-package. For example, one package 12 in the multi-package 10 may contain slab shaped gum products having stain removing ingredients. Another package 12 in the multi-package 10 may contain slab shaped products with teeth remineralization ingredients. A third package 12 in the multi-package 10 may contain pellet shaped products with stain removing and/or remineralization ingredients.

Moreover, the multi-package could include products which are directed to different demographics such as children and adult related products in a single multi-package. It is further contemplated that a single multi-package may include products directed to different demographics such as a family package having, for example, breath freshening for adults and bubble gum for children. For example, one package 12 in the multi-package 10 may be a blister style package targeted to adults and including pellet or slab shaped gum products that each include a breath freshening ingredient. A different package 12 in the multi-package 10 may include the bubble gum in a slab, stick or chunk style format. A third package 12 in the multi-package 10 may be a blister style package containing slab shaped gum products that contain a strong cinnamon or peppermint flavor.

The present embodiment shown herein is directed to gum packaging. The present invention is not limited thereto. In certain embodiments, the product may include a variety of confectionery and non-confectionery products including gum, candy, chocolate or combinations thereof. The product may be packaged or loose. The multi-package may support products of the same type of configuration and packaging or different types of configuration and packaging. Different confectionary products (mints, lollipops, wrapped candy, chocolate, or the like) or non-confectionary products such as prizes, coupons, instructions, pharmaceuticals, puzzle pieces, tokens and the like may also be supported in one or more compartments of a multi-package.

Similarly, one or more of the compartments 13 of the multi-package 10 may include liquid, gel, solids, or powders which can be intermixed with other products in the multi-package.

In a similar fashion, the multi-package could include sprinkles, dust powder, rice bubbles and other items such as marshmallow or fruit pieces and the like.

These techniques may allow a purchaser to purchase a multi-package having different products contained within the multi-package, each sealed from one another and to customize the final product before consumption. It is even contemplated that the multi-package may include a pre-moistened wipe or wrapper for throwing away used confectionary/gum.

While the present invention is being described with respect to a preferred embodiment for separating and sealing individual gum packages, it may be appreciated that the invention is not limited thereto.

Multi-package 10 includes a wrapper 11 formed from a pair of facing planar surfaces 14 and 16. The surfaces 14 and 16 may be formed of a wide variety of materials including polyethylene, polypropylene and combinations thereof. Oriented polyethylene or polypropylene or combinations thereof may also be employed. Such materials are typically used for moisture resistance and sealing capability. However, other suitable materials may also be used. As shown in FIG. 2, a plurality of gum packages 12 are positioned in a vertical spaced apart arrangement such that a heat or other seal may be applied between the gum packages 12. The heat seal effectively fuses the planar surfaces together at a heat sealed location providing a waterproof vapor barrier therebetween. In one embodiment, a heat seal may be effected using conventional heat sealing equipment. The heat seal forms a plurality of compartments 13 each. sealed from one another. The following description will refer to a heat seal, however, it is understood that other seals may also be used.

Each sealed compartment 13 effectively seals the package 12 contained therein from adjacent packages and the environment. The sealed compartment provides an individual moisture barrier around each package and also effectively prevents flavor and aroma migration between compartments and products supported by the multi-package. Flavor migration prevention is particularly advantageous where the multi-package supports a plurality of packages of different flavor types. The individual sealing of the package also allows the package to be protected from dirt and dust contamination and can provide an additional barrier to prevent tapering with the product.

Also, as will be described in further detail hereinbelow, the individual compartments can be selectively removed thereby providing an individually sealed package for the consumer. This allows the consumer to maintain a fresh package even after one compartment is severed from the multi-package.

The heat seal locations extend longitudinally across the planar surface and includes a transverse extent.

A first heat seal location 20 is shown at the upper end of multi-package 10.

A second heat seal location 30 is positioned between two adjacent spaced apart gum packages 12. This heat seal location may optionally include a central longitudinal perforation 32 thereacross. Similarly, a further heat seal location 40 exists between the next successive two adjacent gum packages 12 and optionally includes a longitudinal perforation 42 extending centrally thereacross.

A lower heat seal location 50 exists at the lower end of multi-package 10.

Heat seal location 20 may include an aperture 22 therethrough which allows the wrapper 11 to be hung from a display hook for display and merchandising purposes. It is also contemplated that the other heat seal locations may optionally include an aperture for display and merchandising purposes.

While three gum packages 12 are shown in vertically spaced arrangement, it may be appreciated that additional gum packages may be supported in successive longitudinal array within multi-package 10. Additional heat seals such as described above would form additional compartments 13 to separate each package 12 from the adjacent packages.

As also may be appreciated, the perforations 32 and 42 allow one individually sealed package 12 to be removed from the wrapper while maintaining the seal about the remaining packages 12. The perforations 32 and 42 are positioned centrally along the transverse extent of heat seal so that even when severed thereat, a seal remains around remaining package 12. It is further contemplated that the heat seal location may include on the facing surfaces thereof a releasable adhesive thus allowing the individual compartment once separated from the multi-package to be opened to access the contents and then resealed to reseal the contents in the compartment 13. In that regard, the heat seal location may include therein a tear strip which allows access to the individual compartment 13.

It is further contemplated that the multi-package including the seal locations between the individual packages may be color coded and/or may include indicia which shows the type of product and, in addition, the number of products contained in a multi-package. This would provide an indication that one of the compartments has been removed from the multi-package. Moreover, each compartment 13 may also be of a different color or may include indicia thereon such as a color which relates to the product.

It is, of course, within the contemplation of the present invention that the size, length, width of the seal location can be varied with each multi-package or as between compartments of each multi-package.

As noted above, each of the surfaces 14 and 16 of multi-package 10 may be formed of a single layer of polyethylene or polypropylene. It is further contemplated that additional layers of material may also be employed. Each surface 14 and 16 of multi-package may be formed of multiple layers of polypropylene, polyethylene or other materials and combinations thereof. The multiple layers may be of the same materials or different materials and may be arranged in different alternating layers. In the multi-layered embodiments, one or more of the layers may include indicia thereon.

In one embodiment, an additional layer of material provides strength to the material making it more difficult to tear. This assures that the multi-package will only tear at the perforated lines between each package.

In that regard, as shown in FIG. 3, an edge 17 of the multi-package 10 may include a slit 33 at the longitudinal end thereof. Slit 33 is positioned at the end of perforation 32 and assists in propagating the tear at the perforation 32. The slit may be placed at one or both end of the perforation 32.

In the embodiments of FIGS. 1-4, the multi-package 10 itself may include portions which are colored either translucently or opaquely to enhance the aesthetics or provide information regarding the contents. The opaque or translucent coloring may be coordinated with the theme of the package so that a package containing one type of product may be supplied in a multi-package having coloring which enhances or provides additional information about the contents. For example, the multi-package may be colored translucently or opaquely green for spearmint gum.

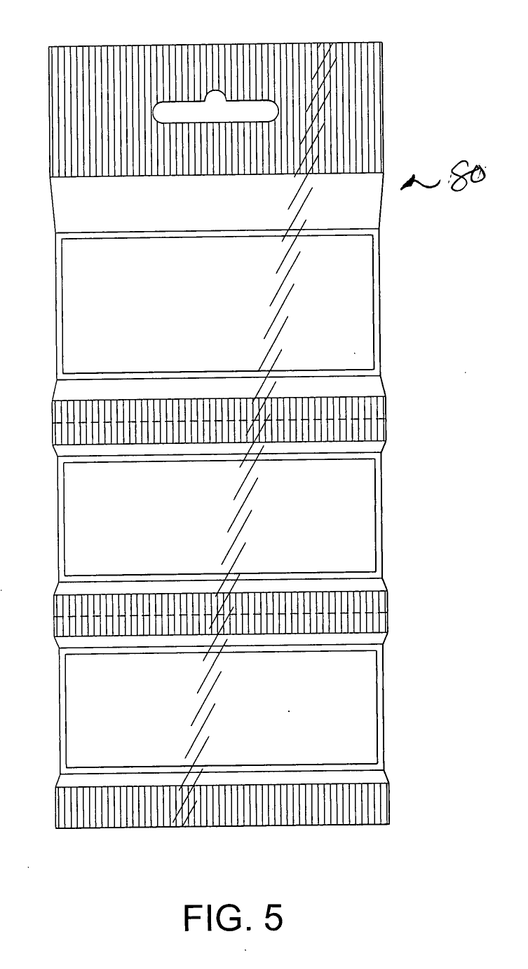

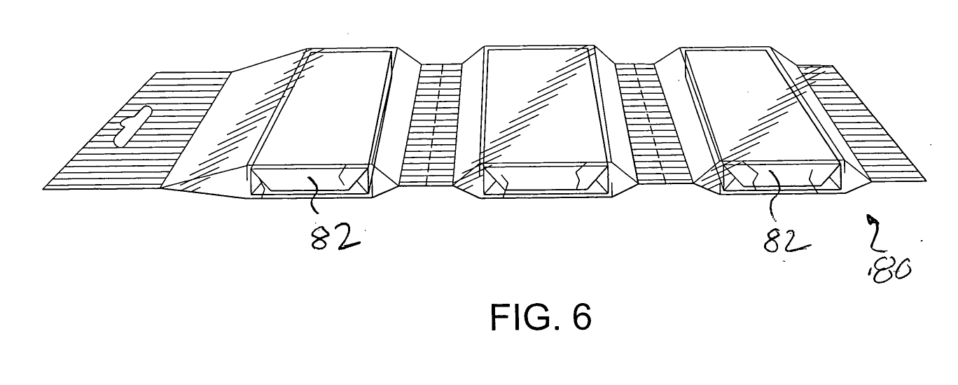

It is further contemplated that, as shown in FIGS. 5 and 6, package 80 may be entirely transparent, allowing the gum packages 82 contained therein to be completely visible. Thus, the package itself provides all of the information to the consumer and is visible through the multi-package. Combinations of opaque, translucent and transparent coloring of the multi-package is also contemplated.

The present invention provides a technique for individually sealing gum packages within in a multi-package arrangement where the multi-package is positioned for display and merchandising and which provides an environmental seal for each of the individually sealed packages thereby also preventing flavor migration therebetween. Moreover, an individually sealed package may be removed from the multi-package maintaining the seal of the remaining packages.

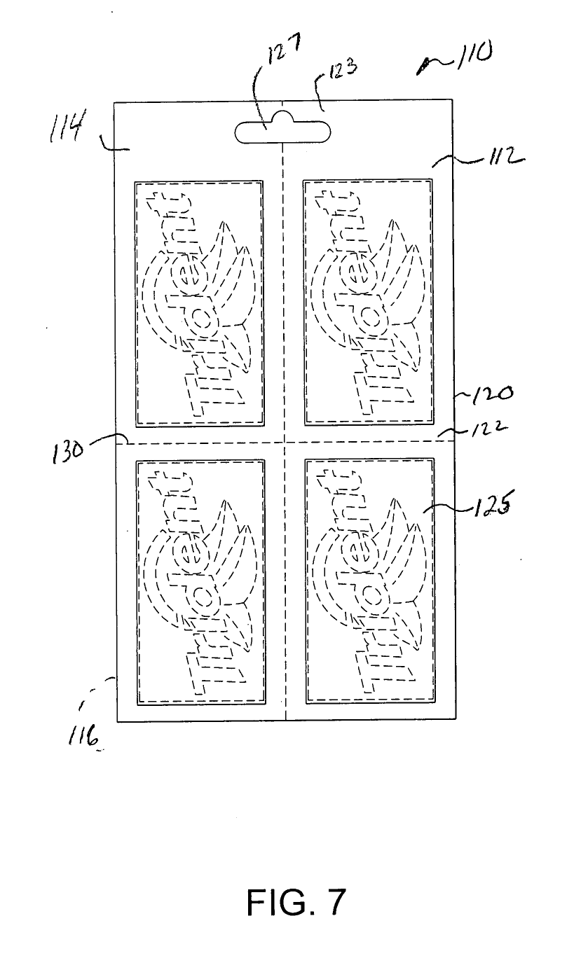

Additionally, as shown in FIG. 7, the multi-package concept of the present invention may be used to form the packages themselves. In this embodiment, the package 110 forms individual packages 112 for containing preferably loose product. Thus, one package 112 may be removed from the remainder and used individually. The multi-package 110 may be sold as a single unit having multiple packages 112.

Multi-package 110 may be formed by opposed planar surfaces 114 and 116. The planar surfaces may be heat sealed together along the peripheral edge 120 and at several locations 122 therebetween so as to form individual bounded package compartments 125 which contain the product. Perforations 130 may be included along the seal locations 122 to allow separation as among the distinct package compartments 125. The upper heat seal locations 123 may also include an aperture 127 which allows the package 110 to be hung from a display hook for display and merchandising purposes.

While the invention has been described in related to the preferred embodiments with several examples, it will be understood by those skilled in the art that various changes may be made without deviating from the fundamental nature and scope of the invention as defined in the appended claims.

What is claimed is:

1. A multi-package for containing a plurality of discrete products, said multi-package comprising:
a wrapper defining a pair of spaced apart planar surfaces for enclosing said products in spaced apart relationship, said surfaces being sealed to each other at locations between said spaced apart products to individually enclose each of said products.

2. A multi-package of claim 1 wherein said products include consumable products.

3. A multi-package of claim 2 wherein said consumable products include a plurality of gum products contained in a gum package.

4. A multi-package of claim 1 wherein said surfaces are heat sealed together.

5. A multi-package of claim 1 wherein said products are arranged in said wrapper in a longitudinal array and wherein said wrapper includes a projecting sealed portion adjacent one end of said array for hanging said multi-package.

6. A multi-package of claim 1 wherein said sealed location includes perforations therealong to allow separation of one of said products.

7. A multi-package of claim 5 wherein said sealed location has a transverse extent and wherein said perforation extends within said transverse extent thereby allowing one of said product to be separated while an adjacent product remains sealed.

8. A multi-package of claim 7 wherein said perforation extends to a least one end of said transverse extent of said sealed location.

9. A multi-package of claim 8 wherein said at least one end of said transverse extent includes a slit aligned with said perforation for propagating a tear thereat.

10. A multi-package of claim 1 wherein said planar surfaces are formed from materials selected from the group consisting of polypropylene, polyethylene and combinations thereof.

11. A multi-package of claim 1 wherein said planar surfaces may include multiple layers of materials selected from the group consisting of polypropylene, polyethylene and combinations thereof.

12. A multi-package of claim 1 wherein each said planar surface includes a first layer of polypropylene and a second layer of polyethylene and wherein indicia is included on said second layer.

13. A multi-package of claim 1 wherein each of said products include ingredients having a functional relationship.

14. A multi-package of claim 1 wherein said products are related by a common theme selected from the group consisting of usage, product benefits, flavors and combinations thereof.

15. A multi-package of claim 14 wherein said products are directed to a common demographic.

16. A multi-package of claim 14 wherein said products are directed to different demographics.

17. A multi-package of claim 1 wherein said products are similar.

18. A multi-package of claim 1 wherein said products are different.

19. A multi-package of claim I wherein said wrapper includes indicia thereon related to the product contained therein.

20. A kit of parts comprising:
a multi-package having a plurality of sealed compartments;
each sealed compartment adapted for supporting in sealed relationship functionally related products.

21. A kit of parts of claim 20 wherein said functionally related products include consumable products having different flavor types.

22. A kit of parts of claim 20 wherein said functionally related products includes consumable products having different health benefits.

23. A kit of parts of claim 20 wherein said multi-package is formed of a pair of planar surfaces which are heat sealed together to form said multi-package.

24. A kit of parts of claim 20 wherein said surfaces are formed from materials selected from the group consisting of polyethylene, polypropylene and combinations thereof.

25. A kit of parts of claim 20 wherein said surfaces are formed of multiple layers of materials selected from the group consisting of polyethylene, polypropylene and combinations thereof.
